(19) United States
(12) Patent Application Publication
(10) Pub. No.: US 2007/0206250 A1
(43) Pub. Date: Sep. 6, 2007

(54) Holographic memory medium, recorder for the same, and recording method for the same

(75) Inventors: Hiroaki Takano, Odawara (JP); Noriko Yamashita, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/711,098

(22) Filed: Feb. 27, 2007

(30) Foreign Application Priority Data
Feb. 27, 2006 (JP) 2006-050767

(51) Int. Cl. G03H 1/02

(52) U.S. Cl. 359/3; 359/24

(57) ABSTRACT

In a recorder for recording optical information in a plurality of recording areas of a holographic memory medium, a recording part records the optical information on a first recording area by multiple-recording; a determining part determines whether the recording in the first recording area has been completed; and a fixing part fixes the optical information on the first recording area in determining that the recording in the first recording area has been completed. The recording part records the optical information in a second recording area by multiple-recording in parallel with or after fixing the optical information in the first recording area when determining that the recording in the first recording area has been completed. Corresponding method and the medium used are also disclosed.

### CROSS REFERENCE TO RELATED APPLICATIONS

This application claims the foreign priority benefit under Title 35, United States Code, §119(a)-(d) of Japanese Patent Application No. No. 2006-050767 filed on Feb. 27, 2006 in the Japan Patent Office, the disclosure of which is herein incorporated by reference in its entirety.

### BACKGROUND OF THE INVENTION

1. Field of the Invention

The present invention relates to a holographic memory medium, a recorder for the same, and a recording method for the same.

2. Description of the Related Art

Examples of high capacity optical recording media which are currently being used or being studied include a digital versatile disk (DVD), a blu-ray disk, and a high definition DVD (HD DVD). However, the capacity of these media is considered to be approximately 100 GB at maximum. Thus, a holographic memory medium has been studied as a high capacity optical recording medium which has a capacity of for more than 100 GB or more.

Since the holographic memory is subject to multiple-recording repeatedly at the same position on a plane by various multiplexing methods, and a plurality of pieces of data are recorded not only in directions within a recording layer but also in the thickness direction of the recording layer, the capacity of the holographic memory medium can be increased. Therefore, there have been many proposals for the holographic memory medium, recording and reproducing devices thereof, and recording and reproducing methods thereof (for example, see Japanese Published Unexamined Patent Application No. 2005-44448, paragraphs 0023 to 0046, FIG. 1 and FIG. 2).

### SUMMARY OF THE INVENTION

A first aspect of the present invention provides a recorder for recording optical information in a plurality of recording areas of a holographic memory medium, comprising: a recording part that performs recording the optical information in a first one of the recording areas by multiple-recording; a determining part that determines whether the recording in the first one of the recording areas is finished; and a fixing part that fixes the optical information in the first one of the recording areas when the determining part determines that the recording in the first one of the recording areas is finished, wherein the recording part records the optical information in a second one of the recording areas by the multiple-recording in parallel with or after fixing the optical information in the first one of the recording areas by the fixing part.

Since the recording and the fixing can be performed parallel, it is not necessary to provide any time required for fixing in addition to the time required for recording. In addition, since the fixing is not performed in an area to which the recording is not performed, the recording can be performed in an area where the fixing is not performed.

In addition, it is preferable that the recording part has a recording light source for recording the optical information and the fixing part has a fixing light source for fixing the optical information. It thus becomes unnecessary to divide light into the fixing light source from the recording light source, and required energy is easily obtained for recording and fixing.

In addition, it is preferable that a recording wavelength of recording light for the recording part to record the optical information is different from a fixing wavelength of fixing light for the fixing part to fix the optical information. Further, it is preferable that the recording wavelength and the fixing wavelength are set so that an absorption (absorbance) of a sensitizing dye contained in the holographic memory medium is larger in the fixing wavelength than in the recording wavelength. Therefore, the sensitizing dye which is contained in the holographic memory medium and causes the chemical reaction can be decreased with low energy.

Further, it is preferable that the recording wavelength is set so that the absorption of the sensitizing dye contained in the holographic memory medium is set to 0.1 or less after fixing in the recording wavelength. Since the reproducing wavelength of the reproducing illumination light irradiated in reproduction is equal to the recording wavelength, the absorption in the recording wavelength is small, and 0.1 or less, thereby reproducing diffraction efficiency is enhanced.

In addition, it is preferable that the recording wavelength and the fixing wavelength are set so that a fixing sensitizing dye contained in the holographic memory medium shows no absorption in the recording wavelength and shows an absorption in the fixing wavelength. Since there is no absorption in the reproduction performed by the same reproducing wavelength as the recording wavelength, the chemical reaction is not caused during reproduction.

A second aspect of the present invention provides a method of recording optical information in a plurality of recording areas of a holographic memory medium, comprising the steps of: recording the optical information in a first one of the recording areas by multiple-recording; determining whether the step of recording the optical information in the first one is finished; fixing the optical information in the first one of the recording areas when the determining part determines that the recording in the first one of the recording areas is finished; and recording the optical information in a second one of the recording areas by the multiple-recording in parallel with or after fixing the optical information in the first one is fixed.

Since the recording and the fixing can be performed parallel, it is not necessary to provide any time required for fixing in addition to the time required for recording. Further, since the fixing is not performed in an area where the recording is not performed, the recording can be performed on an area where the fixing is not performed.

A third aspect of the present invention provides a holographic memory medium for recording optical information, comprising: a recording layer including: a recording sensitizing dye having an absorbance at a recording wavelength of recording light for recording the optical information; and at least one of a fixing sensitizing dye and polymerization initiator which has substantially no absorbance at the recording wavelength and absorbance at the fixing wavelength of fixing light for fixing the holographic memory medium, the absorbance of at least one of the fixing sensitizing dye and the polymerization initiator at the recording wavelength is lower than the absorbance of at least one of the fixing sensitizing dye and the polymerization initiator at the fixing wavelength.

Since the fixing sensitizing dye shows no absorption in the reproduction performed at the same reproducing wavelength as the recording wavelength, the fixing sensitizing dye contributes to the chemical reaction in fixing. However, the fixing sensitizing dye does not contribute to the chemical reaction in reproduction.

A fourth aspect of the present invention provides a holographic memory medium for recording optical information, comprising: a recording layer including: at least one of a sensitizing dye and a polymerization initiator which has an absorption spectrum with a peak for providing a first absorbance at a fixing wavelength of fixing light and a second absorbance at a recording wavelength of recording light, the second absorbance being lower than the first absorbance.

The sensitizing dye which is contained in the holographic memory medium and causes the chemical reaction can be decreased with low energy in fixing to cause sufficient chemical reaction required for fixing.

The sensitizing dye which is contained in the holographic memory medium and causes the chemical reaction can be decreased with low energy in fixing to cause sufficient chemical reaction required for fixing.

### BRIEF DESCRIPTION OF THE DRAWINGS

The object and features of the present invention will become more readily apparent from the following detailed description taken in conjunction with the accompanying drawings in which:

FIG. 1 is a block diagram of a recorder for a holographic memory medium according to a first embodiment of the present invention;

FIG. 2A is a perspective view of the holographic memory medium according to embodiments of the present invention, and FIG. 2B is an enlarged view of an X part of FIG. 2A;

FIGS. 3A and 3B are schematic views showing a process in which optical information is recorded and fixed on the holographic memory medium;

FIG. 4 is a block diagram of a recorder for a holographic memory medium according to a second embodiment of the present invention;

FIG. 5 shows absorption spectrums of a sensitizing dye before recording, after recording and after fixing contained in a recording layer of the holographic memory medium according to a third embodiment of the present invention;

FIG. 6 shows absorption spectrums of a sensitizing dye before recording, after recording and after fixing contained in a recording layer of the holographic memory medium according to the third embodiment of the present invention; and

FIG. 7 shows absorption spectrums of a fixing sensitizing dye before fixing and after fixing included in a recording layer of a holographic memory medium according to a fourth embodiment of the present invention and absorption spectrums of the recording sensitizing dye before recording and after recording.

The same or corresponding elements or parts are designated with like references throughout the drawings.

### DETAILED DESCRIPTION OF THE INVENTION

Prior to describing an embodiment of the present invention, the above-mentioned related art will be further explained.

When optical information is recorded on a holographic memory medium, the holographic memory medium is irradiated with recording light containing the optical information. A chemical reaction is caused in the holographic memory medium by this recording light. A minute scale of this chemical reaction is caused also by reproducing illumination light irradiated during reproduction, and sunlight and illumination light to which the medium is inevitably exposed. Since the chemical reaction due to such reproducing illumination light, etc., gradually changes a state of the recorded information, it is disadvantageous that the reproducing conditions are not retained constant and the recorded information may be erased. Therefore, it is necessary to fix the recorded optical information so that the chemical reaction is not caused by the reproducing illumination light, etc., after recording.

In the fixing, the chemical reaction which may be caused by the reproducing illumination light, etc., is caused in advance. Therefore, even if the holographic memory medium is irradiated with the reproducing illumination light, etc., the chemical reaction is not caused, and the reproducing conditions are fixed. Conventionally, even if the necessity for such a fixing has been pointed out, a method for fixing has not been proposed.

The present invention provides a holographic memory medium capable of being fixed; a recorder capable of fixing the holographic memory medium; and a recording method capable of fixing the holographic memory medium.

With reference to the drawings will be described in details embodiments of the present invention.

### First Embodiment

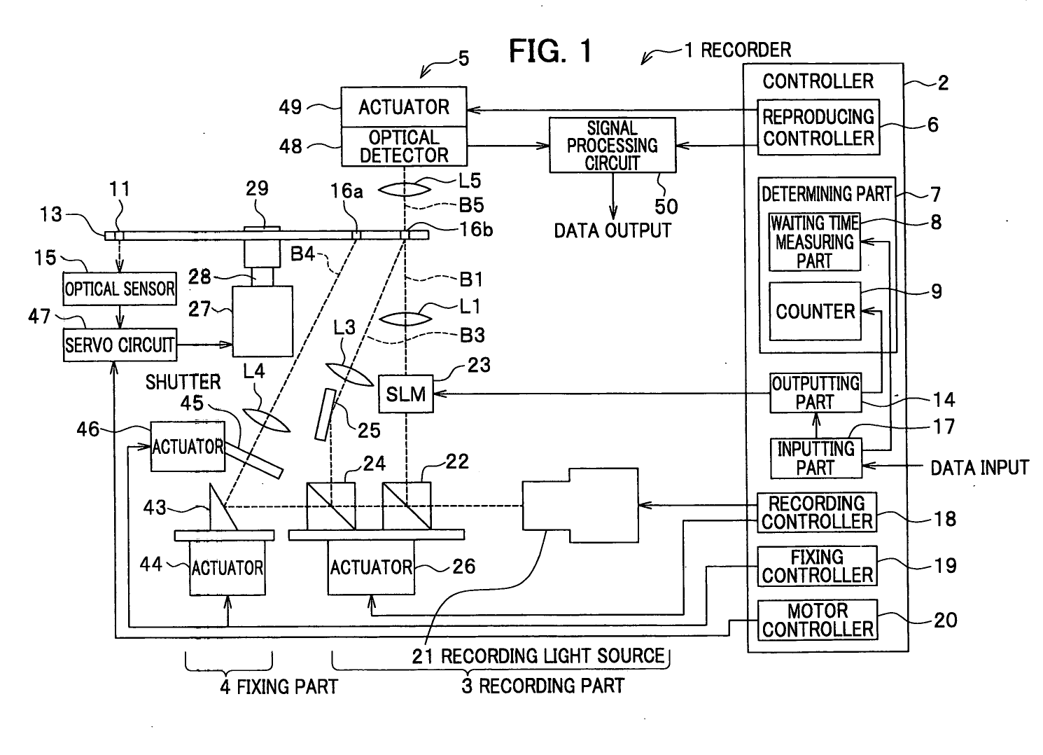

As shown in FIG. 1, a recorder 1 according to a first embodiment is configured for recording optical information in a plurality of recording areas 16a and 16b in a holographic memory medium 13. The recorder 1 includes a recording part 3 for recording the optical information on a first recording area 16a by multiple-recording, a determining part 7 for determining whether recording in the first recording area 16a has been completed, and a fixing part 4 for fixing the optical information in the first recording area 16a when it is determined that the recording in the first recording area 16a has been completed. When it is determined that the recording in the first recording area 16a has been completed, it is possible to fix the first recording area 16a with the fixing part 4. More specifically, it is possible either to complete the recording by the fixing process or to record the optical information in a second recording area 16b by multiple recording in parallel with fixing the optical information on the first recording area 16a with the fixing part 4. Since the recording in the second recording area 16b and the fixing in the first recording area 16a can be performed parallel, it is not necessary to provide time required for fixing in addition to the time required for recording. Since the fixing is not performed in areas other than the recording areas 16a and 16b, the optical information can be recorded at another occasion in the areas where the fixing is not performed.

The recorder 1 is mainly provided with a motor 27 for driving (rotating) the holographic memory medium 13, the recording part 3 for irradiating the holographic memory medium 13 with laser light as recording light B1 and reference light B3, the fixing part 4 for irradiating the holographic memory medium 13 with laser light as fixing light B4, a light receiving part 5 for receiving light transmitted through the holographic memory medium 13, a signal processing circuit 50, a controller 2, and an optical sensor 15 for detecting pits 11 on the holographic memory medium 13.

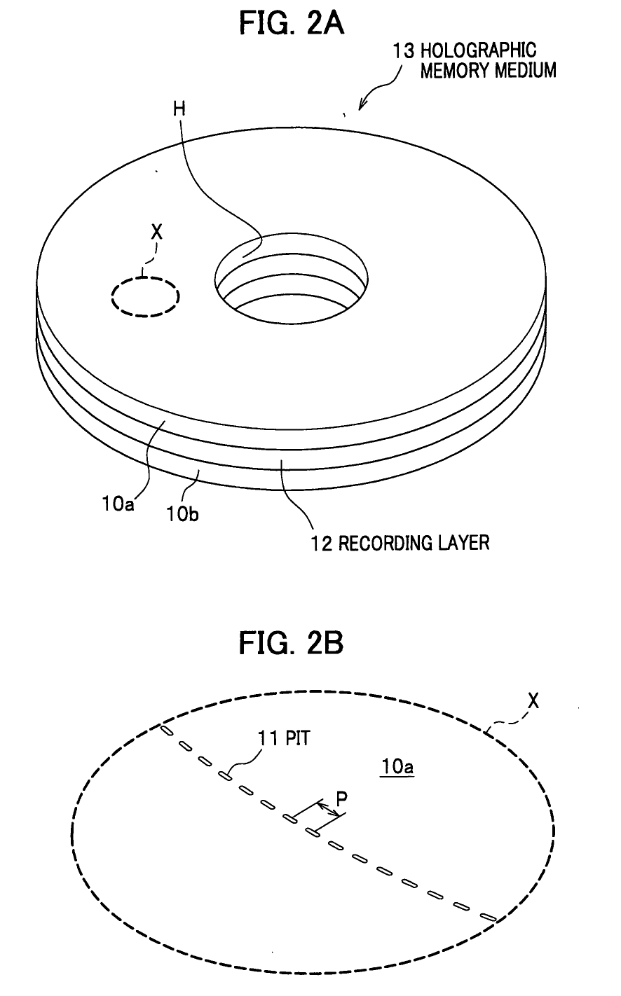

There are provided a spindle 28 and a chuck 29 around the motor 27. The spindle 28 is directly connected to a rotation shaft of the motor 27 to be rotated, and a chuck 29 is provided at a tip of the spindle 28 to engage with a hole H (see FIG. 2A) formed at a center of the holographic memory medium 13.

The recording part 3 includes a recording light source 21, beam splitters 22 and 24, a spatial light modulator (SLM) 23, lenses L1 and L3 and a mirror 25, and an actuator 26.

The beam splitter 22, which is provided on a light path of laser light emitted by the recording light source 21, divides the laser light into a beam including the reference light B3 and the fixing light B4 going straight and the recording light B1 which is reflected in the beam splitter 22 and of which the angle is changed. The beam splitter 24, which is provided on the light path of the beam including the reference light B3 and the fixing light B4, divides the beam into the fixing light B4 going straight through the beam splitter 24 and the reference light B3 which is reflected in the beam splitter 24 and of which the path is changed. Each of the beam splitters 22 and 24 is configured to face, for example, two prisms to each other with a small gap.

The spatial light modulator 23 and the lens L1 are provided on the light path of the recording light B1. The second recording area 16b is irradiated with the recording light B1. The mirror 25 and the lens L3 are provided on the light path of the reference light B3. The second recording area 16b is irradiated with the reference light B3 as in the case of the recording light B1.

The spatial light modulator 23 forms a (two-dimensional) grid pattern indicating input digital data. The spatial light modulator 23, which is arranged on the light path of the recording light B1, converts the input digital data into the optical information as the recording light B1 to form the grid pattern indicating the input digital data on the cross section of the recording light B1. The lens L1 focuses the recording light B1 on a recording layer of the holographic memory medium 13. The mirror 25 bends the light path of the reference light B3, and the lens L3 focuses the reference light B3 on the recording layer of the holographic memory medium 13. The recording light B1 interferes with the reference light B3 on the recording layer of the holographic memory medium 13 to record the optical information as a spot interference pattern.

The actuator 26 integrally moves the beam splitters 22 and 24, the spatial light modulator 23, the lenses L1, L3, and the mirror 25 in the radial direction of the holographic memory medium 13. The second recording area 16b can be set on any area of the holographic memory medium 13 specified by the controller 2 by cooperatively operating the actuator 26 and the motor 27.

The fixing part 4 includes a mirror 43, a shutter 45, a lens L4, and actuators 44 and 46. The mirror 43, the shutter 45, and the lens L4 are provided on the light path of the fixing light B4 which went straight through the beam splitter 24. The first recording area 16a is irradiated with the fixing light B4.

The mirror 43 bends the light path of the fixing light B4. The shutter 45 driven by the actuator 46 transmits and blocks the fixing light B4. The lens L4 focuses the fixing light B4 onto the recording layer of the holographic memory medium 13. A chemical reaction is caused on the recording layer of the holographic memory medium 13 by the fixing light B4, and thereby the optical information recorded as the spot fringe is fixed.

The actuator 44 integrally moves the mirror 43, the shutter 45, the actuator 46 and the lens L4 in the radial direction of the holographic memory medium 13. The first recording area 16a can be set in any area of the holographic memory medium 13 specified by the controller 2 by cooperatively operating the actuator 44 and the motor 27. When the shutter 45 driven by the actuator 46 allows the fixing light B4 to transmit therethrough, the first recording area 16a can be fixed. When the shutter 45 blocks the fixing light B4, the first recording area 16a is prevented from being fixed.

The light receiving part 5 includes a lens L5, an optical detector 48, and an actuator 49. The recorder 1 can also reproduce the optical information recorded on the holographic memory medium 13. The holographic memory medium 13 is irradiated with reproducing illumination light via the same light path as the light path of the reference light B3 from the recording light source 21. The reproducing illumination light is transmitted through the recording layer and is diffracted by the grid fringe in the recording layer, and diffraction light B5 is emitted. The lens L5 and the optical detector 48 are arranged on the light path of the diffraction light B5.

The lens L5 is a collimator lens for collimating the diffraction light B5 emitted from the holographic memory medium 13. The optical detector 48 includes, for example, a CCD (Charge-Coupled Device), etc., having matrix light-receiving elements. The optical detector 48 converts an intensity of the light received by each of the light-receiving elements into an electric signal, and supplies the electric signals to the signal processing circuit 50. The actuator 49 integrally moves the lens L5 and the optical detector 48 in parallel with the actuator 26 in the radial direction of the holographic memory medium 13. The actuator 48 is controlled by the controller 2 as the actuator 26 is. Therefore, the optical detector 48 can surely receive the diffraction light B5.

The signal processing circuit 50 decodes output data detected by the optical detector 48 and reproduces the optical information recorded on the interference fringe in the holographic memory medium 13. The signal processing circuit 50 is connected to the controller 2 in order to output the reproduced optical information, and is connected to an external apparatus (not shown) for outputting the optical information.

The pits 11 are formed in the holographic memory medium 13 in order to determine a position on the holographic memory medium 13. The optical sensor 15 can detect the pits 11. If the rotation of the motor 27 is stopped whenever the pits 11 are detected by a servo circuit 47, the recording area 16b can be formed per the pit 11.

The controller 2 includes a reproducing controller 6, the determining part 7, an outputting part 14, an inputting part 17, a recording controller 18, a fixing controller 19, and a motor controller 20. The reproducing controller 6 controls the recording part 3, the actuator 49 and the signal processing circuit 50 to read out the optical information from the holographic memory medium 13, and operates the signal processing circuit 50 to output the reproduced data.

The inputting part 17 inputs data to be recorded on the holographic memory medium 13. The inputting part 17 transmits the input time to a waiting time measuring part 8 of the determining part 7 whenever data are inputted. The inputting part 17 supplies the input data to the outputting part 14.

The outputting part 14 bundles the input data at a unit determined by a capacity that the spatial light modulator 23 can deal with the input through one recording operation, and supplies the bundled data to the spatial light modulator 23. These bundled data are recorded as a single recording in multiple recording. The outputting part 14 transmits the fact that the bundled data are supplied to a counter 9 of the determining part 7 whenever the bundled data are supplied.

The determining part 7 determines whether the recording of the optical information by the multiple recording in the first recording area 16a performed by the recording part 3 has been completed. The determining part 7 includes the waiting time measuring part 8 and the counter 9, and makes a determination using the waiting time measuring part 8 and the counter 9.

The waiting time measuring part 8 receives time instant at which the data are supplied from the inputting part 17, and measures the inputting interval of the data as waiting time. A predetermined time is previously set in the determining part 7, and the determining part 7 determines whether the waiting time is equal to or more than the predetermined time or less than the predetermined time. The case that the waiting time is equal to or more than the predetermined time is made to correspond to the case where the recording of the optical information on the first recording area 16a by multiple recording has been completed. The case that the waiting time is less than the predetermined time is made to correspond to the case where the optical information on the first recording area 16a by multiple recording is continuously recorded and is not completed. Therefore, even if the multiple recording can still be performed on the first recording area 16a, it can be determined that the multiple recording is not performed any more, and it can be determined that the recording of the optical information by the multiple recording on the first recording area 16a has been completed.

The counter 9 receives information indicating that the bundled data from the outputting part 14 are outputted, and counts the number of times of outputting the bundled data. This number of times corresponds to the number of times of the conducted multiple recording. The specified number of times of multiple-recording is previously set in the determining part 7, and the determining part 7 determines whether the counted number reaches the specified number or the number is less than the specified number. The case that the number of times is identical with the specified number is made to correspond to the case where the recording of the optical information by multiple recording on the first recording area 16a has been completed. The case that the number of times is less than the specified number is mad to correspond to the case where the recording of the optical information by multiple recording on the first recording area 16a is continued and is not completed. This can determine the completion of recording of the optical information in the first recording area 16a by performing the multiple recording the specified number of times.

The recording controller 18 controls the recording part 3, and records the optical information in the first recording area 16a and second recording area 16b of the holographic memory medium 13 by the multiple recording. The fixing controller 19 controls the fixing part 4 and fixes the first recording area 16a and second recording area 16b of the holographic memory medium 13. Based on the information of the position of the pits 11 of the optical sensor 15, the motor controller 20 controls the servo circuit 47 to rotate the motor 27 to rotate the holographic memory medium 13 so as to fix the optical information in the first recording area 16a of the holographic memory medium 13 and to record the optical information in the second recording area 16b.

As shown in FIG. 2A, the holographic memory medium 13 has a disk shape and a center hole H at a central thereof for allowing the chuck 29 of the recorder 1 to insert thereinto. The holographic memory medium 13 is provided with a first optically-transparent substrate 10a, a second optically-transparent substrate 10b, and a recording layer 12 interposed between the first optically-transparent substrate 10a and the second optically-transparent substrate 10b. Since the first optically-transparent substrate 10a and the second optically-transparent substrate 10b are provided for protecting the recording layer 12, the recording layer 12 only needs to be provided for performing functions for recording, fixing and reproducing.

As shown in FIG. 2B, the pits 11 for determining the recording area and fixing position of the optical information are formed on the holographic memory medium 13. The pits 11 are obtained by locally deforming the holographic memory medium 13 into minute hollows formed at equal intervals. The pitch P is set to 0.5 μm to 100 μm. Since a light reflectance of the pits 11 is lower than that of the position where the pits 11 are not formed, the pits 11 can be detected by the light received by the optical sensor 15. The shape of the pit 11 is not particularly limited, and may be a long hole. In this case, the length may be set to 0.4 μm to 3 μm, and the width may be set to approximately 0.4 μm.

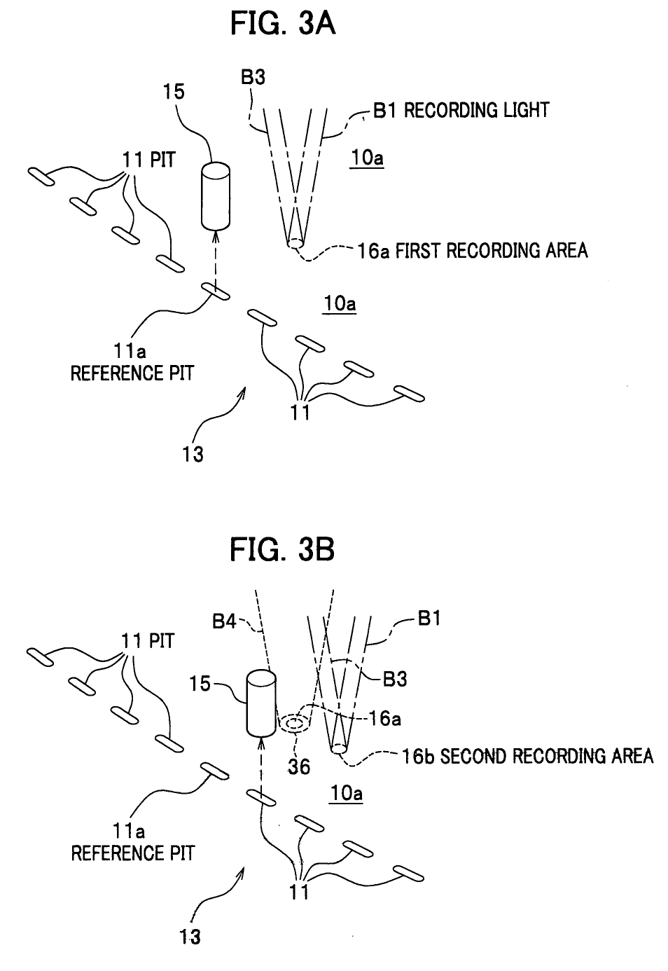

Next, the method for recording the optical information on the holographic memory medium 13 will be described. First, the holographic memory medium 13 is attached to the chuck 29 of the recorder 1 via the center hole H. While the holographic memory medium 13 is rotated at a predetermined angle around the spindle 28, as shown in FIG. 3A, the optical sensor 15 on the side of the recorder 1 consecutively detects the pits 11 formed on the holographic memory medium 13. The motor 27 stops the rotation of the holographic memory medium 13 at the position where the optical sensor 15 detects a reference pit 11a arranged at the reference position among the plurality of pits 11. Thus, the first recording area 16a corresponding to the reference pit 11a is positioned.

The recording layer 12 in which records the optical information is recorded on the first recording area 16a corresponding to the reference pit 11a by the multiple-recording is irradiated with the reference light B3 and the recording light B1, and thereby the optical information as data are multiple-recorded in a form of the interference pattern. As the multiple mode, there can be used a shift multiple mode, an angle multiple mode, a wavelength multiple mode, a phase code multiple mode, a polytopic multiple mode, and a multiple recording provided by the combination thereof. The reference light B3 and the recording light B1 may be provided by a two light beam method in which reference light B3 and the recording light B1 pass through different light paths as shown in FIG. 1, or may be provided by a collinear method in which reference light B3 and the recording light B1 passes through the same light path. In the first embodiment, the angle multiple mode of the two light beam method will be described for easy understanding.

In the angle multiple method, the incidence angle of the reference light B3 is changed for each radiation of recording light B1 of optical information to be multiple-recorded. Specifically, first, the reference light B3 set to a predetermined incidence angle is mixed with the recording light B1 of the optical information, and the recording area 16a of the recording layer 12 is irradiated with the recording light B1 and the reference light B3, and the interference pattern is formed in the recording layer 12.

When the interference pattern is recorded in the recording layer 12, the material of the recording layer 12 causes the chemical change along the light and dark parts of the interference pattern in the recording layer 12 to generate the refractive index difference and the transmissivity difference, and the optical information is recorded. Examples of the materials for the recording layer 12 which have been currently studied include a photopolymer material, a dye type material for modulating refractive index, a silver halide, dichromated gelatin, a photorefractive material and a photochromic material.

Since the photopolymer material provides high diffraction efficiency and shows a low noise characteristic and a favorable preservation stability if the photopolymer material is completely fixed after recording, attention has been focused on the photopolymer material, and the material development has been advanced. The typical photopolymer material contains a binder, a polymerizable monomer, a sensitizing dye and a polymerization initiator, etc.

A binder and monomer having different refractive indexes are used. The light part and dark part of the interference pattern are formed in the recording layer 12 during recording. The sensitizing dye is excited in the light part of the interference pattern to emit electrons, and the emitted electrons are moved to the polymerization initiator. The polymerization initiator generates radicals, and the radicals are moved to the monomer to perform the polymerization reaction of the monomer. As a result, the monomers to be polymerized are transferred also from the adjacent dark part to the light part of the interference pattern, and the monomer becomes rich. In accordance with the transfer of the monomer the binder becomes rich in the dark part of the interference pattern. The different refractive index due to the monomer rich state and the binder rich state is generated in the light part and dark part of the interference pattern, and thereby the interference pattern is recorded. As a result, the optical information is recorded in the recording layer 12 as a pattern expressed as the different refractive index or light transmission.

Next, the incidence angle of the reference light B3 is changed by changing the heights of the mirror 25 and lens L3 of FIG. 1, and the angle of the mirror 25, and the reference light B3 is mixed with the recording light B1 carrying the other optical information. The other optical information is recorded in an overlaying manner by forming the interference pattern on the same first recording area 16a as the recording area where the optical information had been recorded before changing the angle of the reference light B3. In the same manner, each beam of the reference light B3 having a different incidence angle is mixed with the recording light B1 of the other optical information to be multiple-recorded, and thereby the plurality of pieces of the optical information are multiple-recorded on the one first recording area 16a of the recording layer 12.

The determining part 7 then determines whether the recording has been completed on the first recording area 16a. The recording part 3 performs the multiple-recording until the determining part 7 determines that the recording in the first recording area 16a has been completed.

When the determining part 7 determines that the multiple-recording in the first recording area 16a has been completed, the holographic memory medium 13 is again rotated around the spindle 28. As shown in FIG. 3B, the optical sensor 15 detects the next pit 11 which is arranged adjacent to the reference pit 11a and stop the rotation of the holographic memory medium 13, and thereby the second recording area 16b which is to be irradiated with the recording light B1 and the reference light B3 is positioned. In addition, the first recording area 16a and the second recording area 16b may be overlapped or may not be overlapped. A plurality of pieces of the optical information are multiple-recorded in the second recording area 16b using the positioned recording light B1 and reference light B3 as multiple-recorded in the first recording area 16a.

When the determining part 7 determines that the recording in the first recording area 16a has been completed parallel to the multiple-recording on the second recording area 16b, the optical information is fixed on the first recording area 16a where the recording has just been completed. The first recording area 16a is irradiated with the fixing light B4 for fixing. A fixing location 36 by the fixing light B4 on the holographic memory medium 13 is set so as to contain the first recording area 16a. Therefore, a most part of the chemical reaction such as the polymerization reaction of the polymerizable monomer in the fixing location 36 occurs in fixing, and thus the unreacted polymerizable monomer is decreased after fixing. Therefore, even if the unreacted polymerizable monomer is reacted after fixing, the condition for reproducing the optical information recorded as the interference pattern is not substantially changed whenever being reproduced since the amount of the polymerizable monomer is small.

Hereinafter, similarly, when the determining part 7 determines that the multiple-recording of the predetermined optical information in the second recording area 16b has been completed, the fixing location 36 is shifted to the second recording area 16b, and the recording location is shifted to a new recording area by the so-called stop and go method as described above. In this operation, the time required for fixing is set shorter than the time required for multiple-recording, and the fixing to the first recording area 16a has been completed before the multiple-recording to the second recording area 16b has been completed. The time required for fixing can be adjusted by the time interval of opening/closing of the shutter 45.

Hologram as the optical information recorded on the recording layer 12 is read out as the reproducing light which is the diffraction light B5 generated by irradiating the first recording area 16a and the second recording area 16b with the reproducing illumination light. Each of the plurality of pieces of optical information which are multiple-recorded on the first recording area 16a and the second recording area 16b are read out by irradiating the reproducing illumination light set to the incidence angle of the reference light B3 when each optical information is recorded.

The recording layer is a layer on which the optical information is recorded by the irradiation of light. The thickness of the recording layer is 200 μm or more, preferably 0.2 to 2.5 mm, and more preferably 0.5 to 2.5 mm. The number of times of the multiple-recording required in the holographic memory as a commercial product can be satisfied by setting the thickness to 200 μm or more. Regarding the SN ratio of the reproduced optical information, the SN ratio required for a commercial product can be satisfied by setting the thickness to 0.5 mm or more. The material which does not contribute to the recording of the optical information can be reduced by setting the thickness to 2.5 mm or less, which reduces the cost in the manufacturizing.

The polymerizable monomer is not particularly limited as long as the polymerizable monomer has a polymerizable group. Examples thereof include a radical polymerizable monomer, a cationic polymerizable monomer, and the monomers using these together, and specific examples include compounds containing polymerizable groups such as an epoxy group and an ethylenic unsaturated group. Any polymerizable monomer can be used as long as it contains one or more of the above-mentioned polymerizable group is contained in a molecule. If the polymerizable groups of the polymerizable monomer include two or more of the polymerizable groups in the molecule, the polymerizable groups may be different or the same.

Although the sensitizing dye is not particularly limited as long as the sensitizing dye has an absorption (absorbance) in the recording wavelength of the recording light B1 (reference light B3), it is preferable that the absorption of the sensitizing dye in the recording wavelength, that is, the optical absorption coefficient ε be low. Specific examples of the sensitizing dyes include known organic dyes such as a cyanogen dye, a merocyan dye, a phthalocyan dye, an azo dye, an azomethine dye, an indoaniline dye, a xanthene dye, a coumalin dye, a polymethine dye, a diallylethene dye, a flugidofluoran dye, an anthraquinone dye, and a styryl dye. In addition, as the sensitizing dye, complex dyes may be used.

Examples of the polymerization initiators include a radical generating agent, a cation generating agent, and an acid generating agent.

Examples of the binders include chlorinated polyethylene, polymethylmethacrylate, a copolymer of methylmethacrylate and other alkyl(meth)acrylate ester, a copolymer of vinyl chloride and acrylonitrile, polyvinyl acetate, polyvinyl alcohol, polyvinyl formal, polyvinyl butyral, polyvinyl pyrrolidone, ethyl cellulose, acetylcellulose and polycarbonate. Regarding the refractive index of the binder, the difference between the refractive index of the binder and that of the polymer of the polymerizable monomer is preferably larger. However, when the difference of the refractive indexes is too large, the compatibility of the binder and polymerizable monomer is reduced, and as a result, the scattering of light may be increased. Therefore, a binder having an appropriate refractive index is required.

The recording layer 12 may contain materials generally used for the formation of the recording layer of the optical recording medium of this kind such as a sensitizer, an optical brightening agent, an ultraviolet absorption agent, a heat stabilizer, a chain transfer agent, a plasticizer and a colorant if needed.

The photopolymer material records the interference pattern using the refractive index difference of the binder and the polymer which is obtained by polymerizing the polymerizable monomer, and the monomer is present in a urethane matrix formed by the cross-linking reaction due to the heat of polyol and the curing agent. In the formation of the recording layer due to the photopolymer material, there can be used a method for forming a film by spin coat using a solution in which the photopolymer material is dissolved in the solvent, or for injecting the solution into a substrate.

Examples of the materials for the recording layer which have been currently studied other than photopolymer material include dye materials for modulating refractive index. The dye material for modulating refractive index causes the chromogenic reaction or decolorization reaction of the dye for modulating refractive index in the light part of the interference pattern, and produces a difference in physical property values such as the refractive index difference and the transmissivity difference relative to the dark part of the interference pattern. The dye material for modulating refractive index includes a binder, a sensitizing dye, a dye for modulating refractive index, and an acid generating agent. When the interference pattern is generated as in the photopolymer, the sensitizing dye is excited in the light part of the interference pattern, and the electrons are emitted. The emitted electrons are moved to the acid generating agent, and the acid is generated. The dye for modulating refractive index is decolorized by the decolorization reaction due to the acid, and the refractive index is changed. Alternatively, the dye for modulating refractive index is colored by the chromogenic reaction, and the refractive index is changed. In the chromogenic reaction, the dye for modulating refractive index may be particularly referred to as a dye precursor.

The recording layer 12 contains the sensitizing dye and the dye for modulating refractive index. Although the sensitizing dye and the dye for modulating refractive index are not particularly limited as long as they abosorb the recording wavelength of the recording light (reference light), it is preferable that they have a low absorption of the sensitizing dye, that is, a low optical absorption coefficient e, in the recording wavelength. As the sensitizing dye, the same sensitizing dye as those contained in the photopolymer material can be used.

The dye material for modulating refractive index has a binder containing a dye and records the interference pattern by the refractive index change due to the coloring and decolorization of the dye of an optical exposure part, and the sensitizing dye and the dye for modulating refractive index are contained in the binder. In the formation of the recording layer using the dye materials for modulating refractive index, there can be used a method for forming a film by spin coat using a solution in which the dye materials for modulating refractive index is dissolved in the solvent, or for injecting the solution into a substrate.

Also, examples of the materials of the recording layer 12 which have been currently studied include a silver halide, dichromated gelatin, a photorefractive material, and a photochromic material.

Although the silver halide has a high sensitivity and comparatively a high resolution, the silver halide has the problems that a wet processing is required and is complicated; the scattering is large; and the light resistance is poor. Therefore, as the memory application, improvement is required.

Although the dichromated gelatin has a high diffraction efficiency and a low noise, the dichromated gelatin has low sensitivity and unfavorable recording preservability, and thereby the dichromated gelatin requires improvement for the memory application.

Although the photorefractive material has a characteristic capable of being rewritten, the photorefractive material requires a high voltage application in recording and has unfavorable recording retention property, and thereby the photorefractive material requires improvement for the memory application.

Although the photochromic material also has a characteristic capable of being rewritten, the photochromic material has a very low sensitivity and unfavorable recording holding property, and thereby the photochromic material requires improvement for the memory application.

Then, materials of the recording layer 12 such as the silver halide, the dichromated gelatin, the photorefractive material, the photochromic material, the photopolymer material and the dye material for modulating refractive index may be used in combination. For example, by combining the dye material for modulating refractive index which causes the chromogenic reaction or the decolorization reaction with the photopolymer material which causes the polymerization reaction, the fixing can be performed also on the dye material for modulating refractive index, and the refractive index difference can be easily obtained. Therefore, an aptitude as the material of the recording layer can be synergistically obtained. Further, if the photorefractive material and the photopolymer material are used in combination, the fixing can be similarly performed also on the photorefractive material, and the refractive index difference can be easily obtained. Thereby, the aptitude as the material of the recording layer 12 can be synergistically obtained. The recording layer 12 may be made of a thermal polymerizable resin composition (thermosetting resin composition) in accordance with the recording method.

The thickness of each of the optically-transparent substrates 10a and 10b needs only to be approximately 0.05 to approximately 1.2 mm. Examples of the materials for the optically-transparent substrate include inorganic substances such as glass, and resins such as polycarbonate, triacetyl cellulose, cycloolefin polymer, polyethylene terephthalate, polyphenylene sulphide, an acrylic resin, a methacrylic resin, a polystyrene resin, a vinyl chloride resin, an epoxy resin, a polyester resin and an amorphous polyolefin resin. Among these, the glass, the polycarbonate and the triacetyl cellulose are preferable since they have small double reflex. The optically-transparent substrates 10a and 10b may be made of the same material, or they may be made of a different material. A reflection preventive coating, an oxygen permeation preventive coating, a moisture permeation preventive coating and a UV cut coating, etc., may be applied to the surfaces of the optically-transparent substrates 10a and 10b if needed.

Since the first embodiment can provide the recorder 1 which can fix the holographic memory medium 13, and the recording and the fixing can be performed parallel, it is not necessary to provide the time required for fixing separately from the time required for recording. Since the fixing is not collectively performed on the entire surface of the holographic memory medium 13, and the fixing is not performed in the area in which the optical information is not recorded, the optical information can be newly recorded in the area in which the fixing is not performed.

### Second Embodiment

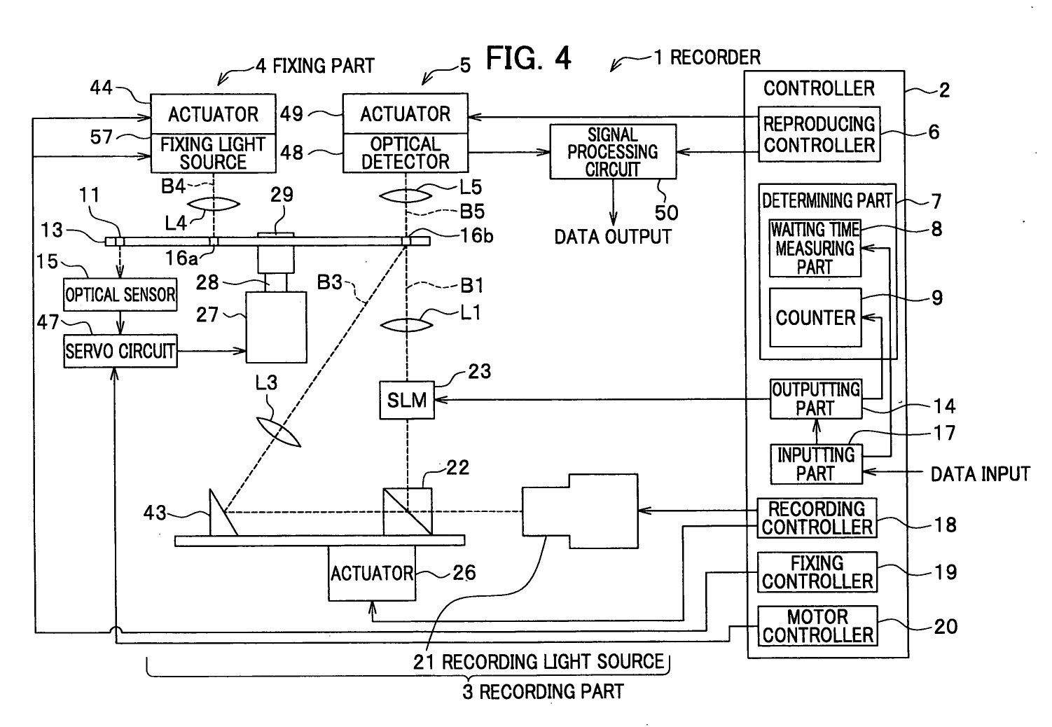

As shown in FIG. 4, the recorder 1 according to the second embodiment is substantially the same as that of the first embodiment of FIG. 1 except that the recorder 1 has a fixing light source 57. Therefore, the recording part 3 and the fixing part 4 according to the second embodiment are different from those in the first embodiment. In the recording part 3, the mirror 43 is moved by the actuator 26, and the reference light B3 is reflected by the mirror 43. The fixing part 4 includes the fixing light source 57 which emits the fixing light B4, the lens L4 which focuses the fixing light B4 on the holographic memory medium 13, and an actuator 44 which moves the light path of the fixing light B4 to the first recording area 16a.

Since the second embodiment provides the effects in the first embodiment and also has the recording light source 21 for the recording part 3 to record the optical information and the fixing light source 57 for the fixing part 4 to fix the optical information, it becomes unnecessary to divide the fixing light B4 for fixing from the recording light source 21, and energy required for the recording light B1 and the reference light B3 are also easily obtained. Also, energy required for the fixing light B4 is easily obtained. Since the recording light source 21 and the fixing light source 57 are discretely included, the recording wavelength of the recording light B1 can be set so as to be different from the fixing wavelength of the fixing light B4. As shown in the third to fifth embodiments to be described below, the recording wavelength and the fixing wavelength can be set so that the recording wavelength and the fixing wavelength are different from each other, and the sensitizing dye or the polymerization initiator which is contained in the holographic memory medium 13 and causes the chemical reaction can be decreased with a low energy in fixing.

### Third Embodiment

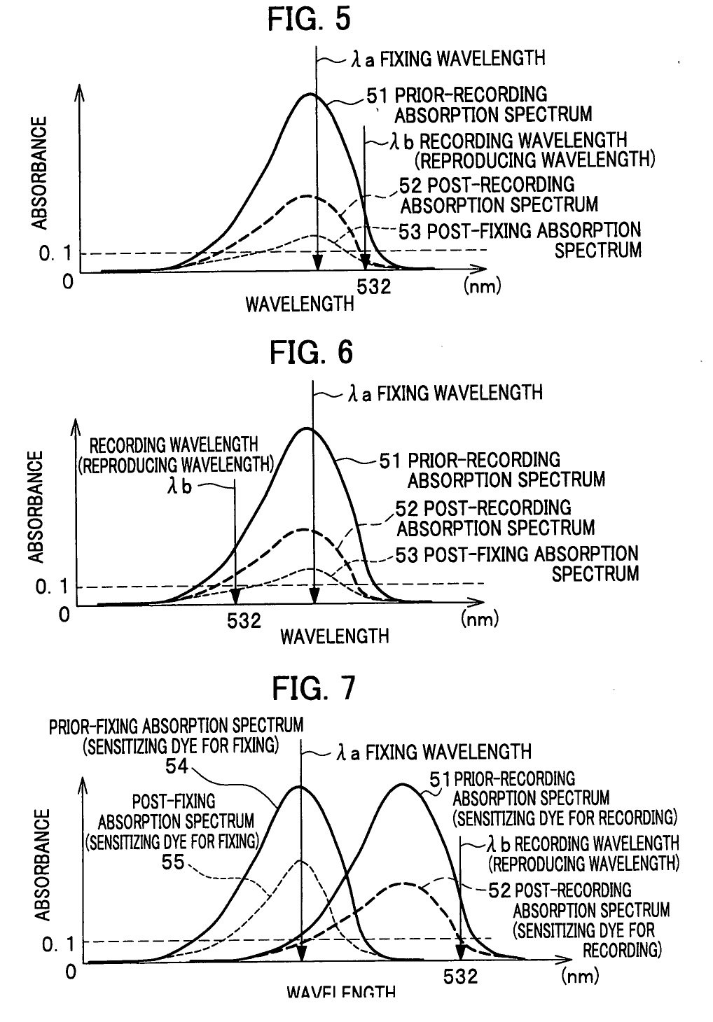

A third embodiment can also use the recorder 1 of the second embodiment. As shown in FIG. 5, this is because the fixing wavelength λa of the fixing light B4 is different from the recording wavelength λb corresponding to the reproducing wavelengths of the recording light B1, the reference light B3 and reproducing illumination light in reproduction. Therefore, the effects obtained by the second embodiment can be obtained in the third embodiment.

Furthermore, the absorption of the sensitizing dye contained in the recording layer 12 of the holographic memory medium 13 is set larger at the fixing wavelength λa than at the recording wavelength λb in the prior-recording absorption spectrum 51 before recording of the sensitizing dye contained in the recording layer 12 of the holographic memory medium 13. Therefore, the sensitizing dye which causes the chemical reaction while consuming the sensitizing dye, is contained in the holographic memory medium 13, and causes the chemical reaction can be decreased with a low energy. The fixing wavelength λa is preferably set to a wavelength in which the absorption becomes the maximum in the prior-recording absorption spectrum 51. Therefore, more sensitizing dye can be decreased with a lower energy. On the other hand, although the recording wavelength λb is not particularly limited as long as the recording wavelength λb is any wavelength absorbed in the sensitizing dye, a wavelength having a low absorption is preferable. The reason is to prevent the situation where the interference pattern is not formed at deep parts, or the situation where interference pattern is not uniformly formed between the incidence side and the deep parts due to the fact that the most part of the recording light B is absorbed on the incidence side and the recording light B does not reach the deep parts. Also, it is because strong reproducing light is obtained without making the recording layer 12 absorb the reproducing illumination light in reproduction as much as possible.

When the recording light B1 is irradiated in recording, the sensitizing dye is decomposed and decreased as shown in a post-recording absorption spectrum 52 of the sensitizing dye. In fixing, it is necessary to further decrease the sensitizing dye which contributes to the chemical reaction. However, if the light of recording wavelength λb is used for fixing, it is necessary to irradiate the sensitizing dye with a large amount of light since the absorption in the recording the sensitizing dye with wavelength λb is further decreased after recording. At this time, the absorption is large in the fixing wavelength λa. When the sensitizing dye is irradiated with the fixing light B4 having the fixing wavelength λa, the sensitizing dye can be reduced with a slight amount of light as shown in a post-fixing absorption spectrum 53 after fixing the sensitizing dye.

As shown in the post-fixing absorption spectrum 53, the recording wavelength λb is preferably set so that the absorption by the sensitizing dye contained in the holographic memory medium 13 is 0.1 or less after fixing in the recording wavelength λb. Since the reproducing wavelength of the reproducing illumination light irradiated in reproduction is equal to the recording wavelength λb, the absorption in the recording wavelength λb is small, that is, 0.1 or less. Thereby, the reproducing illumination light is not absorbed by the recording layer 12; a reproducing light having a high intensity is obtained; and a high reproducing diffraction efficiency is obtained. In the above-described explanation, this absorption value is not compensated by the film thickness of the recording layer 12 and is based on the ratio of the illumination of the penetration light to the illumination of the incidence light to the recording layer 12.

The fixing wavelength λa may be smaller than the recording wavelength λb as shown in FIG. 5, and the fixing wavelength λa may be larger than recording wavelength λb as shown in FIG. 6. When the recording wavelength λb is 532 nm, the fixing wavelength λa may be smaller than 532 nm as shown in FIG. 5, and it may be larger than 532 nm as shown in FIG. 6. The recording wavelength λb may be larger than a wavelength in which absorption becomes the maximum in the prior-recording absorption spectrum 51 before the recording of the sensitizing dye as shown in FIG. 5, and it may be smaller as shown in FIG. 6.

### Fourth Embodiment

The recorder 1 of the second embodiment can also be used in a fourth embodiment. As shown in FIG. 7, this is because the fixing wavelength λa of the fixing light B4 is different from the recording wavelength λb corresponding to the reproducing wavelengths of the recording light B1, reference light B3 and reproducing illumination light in reproduction. Therefore, the effects obtained by the second embodiment can be obtained in the fourth embodiment.

In the prior-recording absorption spectrum 51 of the recording sensitizing dye and a prior-fixing absorption spectrum 54 of the fixing sensitizing dye, both contained in the recording layer 12 of the holographic memory medium 13, the absorption at the fixing wavelength λa is set larger than the absorption at the recording wavelength λb. Therefore, the fixing sensitizing dye is consumed in fixing, and the chemical reaction is advanced. Then, the polymerizable monomer which is contained in the holographic memory medium 13 and causes the chemical reaction can be decreased.

Also, it is preferable that the recording wavelength λb and the fixing wavelength λa be set so that the fixing sensitizing dye contained in the holographic memory medium 13 has no absorption at the recording wavelength λb and has an absorption at the fixing wavelength λa. Since there is no absorption by the fixing sensitizing dye in the reproduction performed in the same reproducing wavelength as the recording wavelength λb, the chemical reaction is not caused by the fixing sensitizing dye during reproduction. Since the fixing sensitizing dye does not absorb the reproducing illumination light during reproduction, strong reproducing light can be emitted. Since the fixing sensitizing dye which contributes to the chemical reaction can be provided in a large quantity on the premise of these effects, the chemical reaction is caused at once during fixing, and the polymerizable monomer, etc., which causes the chemical reaction can be significantly decreased. For this purpose, the fixing wavelength λa is preferably set to a wavelength in which the absorption becomes the maximum in the prior fixing absorption spectrum 54. Therefore, a greater chemical reaction can be caused with a lower energy, and the polymerizable monomer, etc., can be further decreased. On the other hand, although the recording wavelength λb is not particularly limited as long as the recording wavelength λb is a wavelength absorbed in the recording sensitizing dye in the prior-recording absorption spectrum 51, a wavelength having a low absorption is preferable.

On the contrary, in order to obtain the holographic memory medium 13 having these effects, the recording layer 12 contains the recording sensitizing dye having an absorption in the recording wavelength λb of the recording light B1 and the fixing sensitizing dye having no absorption in the recording wavelength λb and having an absorption in the fixing wavelength λa of the fixing light B4.

### EXAMPLES

Next, although the holographic memory medium 13 of the present invention is more specifically described based on Examples, the present invention is not limited to these Examples.

### <Manufacture of Holographic Memory Medium>

### Example 1

In Example 1, the holographic memory medium 13 was manufactured using a photopolymer material. First, a solution was prepared in order to produce a recording layer. Materials such as a binder, monomer, sensitizing dye 1, polymerization initiator and methylene chloride as a solvent shown in Table 1 were weighed so as to have weights shown in Table 1. The materials were weighed under a red light.

TABLE 1

| | Material | Weight (g) |
|---|---|---|
| Binder | PMMA-EA | 10000 |
| Monomer | POFA (see structural formula (a)) | 3000 |
| Sensitizing dye 1 | DEAW (see structural formula (b)) | 1 |
| (for recording) | | |
| Polymerization | MBO (see structural formula (c)), | 260 |
| initiator | o-C1-HABI (see structural formula (d)) | 170 |
| Solvent | Methylene chloride | 40000 |
| | MEK | 4500 |

PMMA as the binder in Table 1 is polymethylmethacrylate (manufactured by Aldrich Company, MW: 996000). Also, POEA as the monomer is a compound represented by a formula (a).

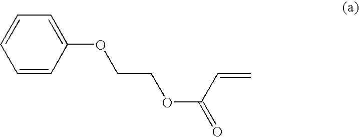

DEAW as the sensitizing dye 1 is a compound represented by a structural formula (b). Since the DEAW as the sensitizing dye 1 has a larger absorption Abs at a wavelength of 488 nm than at a wavelength of 532 nm or 405 nm (Abs at 488 nm>Abs at 532 nm (or Abs at 405 nm)), as shown in FIG. 5 of the third embodiment, the fixing is efficiently performed by dividing the recording wavelength λb and fixing wavelength λa, for example, setting the recording wavelength λb to 532 nm or 405 nm, setting the fixing wavelength λa to 488 nm, rather than setting the recording wavelength λb and the fixing wavelength λa to the same 532 nm.

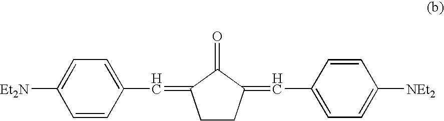

MBO as the polymerization initiator is a compound represented by a formula (c). o-C1-HABI as the polymerization initiator is a compound represented by a formula (d).

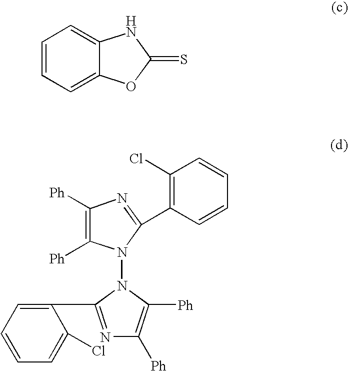

MEX as the solvent is methyl ethyl ketone.

### Example 2

Also in Example 2, as in Example 1, a holographic memory medium 13 was manufactured using a photopolymer material. Example 2 is performed in the same manner as in Example 1 except that a solution is prepared by adding the sensitizing dye 2 (for fixing) other than the sensitizing dye 1 (for recording) of Example 1 as the sensitizing dye in Example 2 as shown in Table 2.

TABLE 2

| | Material | Weight (g) |
|---|---|---|
| Binder | PMMA-EA | 10000 |
| Monomer | POEA (see formula | 3000 |
| | (a)) | |
| Sensitizing dye 1 | DEAW (see formula | 1 |
| (for recording) | (b)) | |
| Sensitizing dye 2 | See structural | 4 |
| (for fixing) | formula (e) | |
| Polymerization | MBO (see formula (c)) | 260 |
| initiator | o-C1-HABI (see | 170 |
| | formula (d)) | |
| Solvent | Methylene chloride | 40000 |
| | MEK | 4500 |

The sensitizing dye 2 is a compound represented by a structural formula (e). The sensitizing dye 2 has maximum absorption near a wavelength of 405 nm in the absorption spectrum (λmax=405 nm). The sensitizing dye 2 has no absorption at a wavelength of 532 nm or more, and the absorption becomes zero. For example, as shown in FIG. 7 of the fourth embodiment, the recording wavelength λb is set to 532 nm, and the fixing wavelength λa is set to 405 nm. The sensitizing dye 1 corresponds to the recording sensitizing dye, and the absorption spectrum of the sensitizing dye 1 corresponds to the absorption spectrums 51 and 52 of the recording sensitizing dye. The sensitizing dye 2 corresponds to the fixing sensitizing dye, and the absorption spectrum of the sensitizing dye 2 corresponds to the absorption spectrums 54 and 55 of the fixing sensitizing dye. Therefore, since the absorption is increased even with a little light in fixing, light can be fully absorbed to cause various chemical reactions, and the fixing can be efficiently performed.

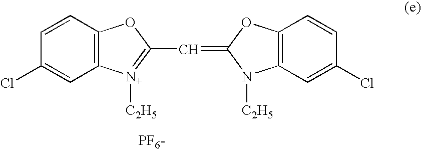

After solutions were prepared according to compositions of Tables 1 and 2 of Examples 1 and 2, substrates were coated for every solution, and were sufficiently dried. Another substrate was bonded by thermal compression in a vacuum so that air bubbles do not intrude into the surface of the solution, and a holographic memory medium 13 for evaluation was produced. Although an optically-transparent substrate such as a polycarbonate can be used for the substrate, the substrate must be coated so as not to be invaded by the solvent contained in the prepared solution.

### <Measurement of Bit Error Rate (BER) of Holographic Memory Medium 13>

Optical information was recorded and fixed on each of the manufactured holographic memory mediums 13 of Example 1 and Example 2 using the recorder 1 of the second embodiment. Both the recording wavelengths λb of Example 1 and Example 2 were set to 532 nm. The fixing wavelength λa of Example 1 was made to correspond to the third embodiment of FIG. 5, and was set to 488 nm. The fixing wavelength λa of Example 2 was made to correspond to the fourth embodiment of FIG. 7, and was set to 405 nm. An image was used as the optical information.

Example 1 and Example 2 confirmed that an absorption Abs by the sensitizing dye contained in the holographic memory medium 13 in the recording wavelength λb after fixing was 0.1 or less.

Again, the optical information recorded and fixed was reproduced using the recorder 1 of the second embodiment. Both the reproducing wavelengths of Example 1 and Example 2 were set to 532 nm which is the same as the recording wavelength λb. The reproduction was repeatedly performed 10000 times. BER was computed by comparing the images reproduced in the first reproducing, the 1000th reproducing and the 10000th reproducing with the original image used for recording and fixing.

Example 1 and Example 2 confirmed that BER in the first reproducing, the 1000th reproducing and the 10000th reproducing was not deteriorated. Thus, Example 1 and Example 2 demonstrated that there was provided the holographic memory medium 13 fixed so that the BER is not deteriorated by reproducing.

As mentioned above, in the recorder 1, the recording part records the optical information in the recording area 16a by the multiple-recording in parallel (along) with or after fixing the optical information in the first recording area 16b by the fixing part 4. Further, in the recorder 1, the fixing part locally fixes the optical information in the first recording area 16a.

Further, the holographic memory medium includes at least one of the sensitizing dye and the polymerization initiator, for staring polymerization which has a first absorbance at the recording wavelength and a second absorbance at the fixing wavelength, wherein the second absorbance at the fixing wavelength is made higher than the first absorbance.

In addition, in the holographic memory medium 13, the recording layer 12 includes: a recording sensitizing dye having an absorbance at a recording wavelength of recording light for recording the optical information; and at least one of a fixing sensitizing dye and polymerization initiator which has substantially no absorbance at the recording wavelength and absorbance at the fixing wavelength of fixing light for fixing the holographic memory medium, the absorbance of at least one of the fixing sensitizing dye and the polymerization initiator at the recording wavelength is lower than the absorbance of at least one of the fixing sensitizing dye and the polymerization initiator at the fixing wavelength.

Further, in the holographic memory medium 13, the recording layer 12 includes: at least one of a sensitizing dye and a polymerization initiator which has an absorption spectrum with a peak for providing a first absorbance at a fixing wavelength of fixing light and a second absorbance at a recording wavelength of recording light, the second absorbance being lower than the first absorbance.

The invention claimed is:

1. A recorder for recording optical information in a plurality of recording areas of a holographic memory medium, comprising:
a recording part that performs recording the optical information in a first one of the recording areas by multiple-recording;
a determining part that determines whether the recording in the first one of the recording areas is finished; and
a fixing part that fixes the optical information in the first one of the recording areas when the determining part determines that the recording in the first one of the recording areas is finished,
wherein the recording part records the optical information in a second one of the recording areas by the multiple-recording in parallel with or after fixing the optical information in the first one of the recording areas by the fixing part.

2. The recorder according to claim 1, wherein the recording part includes a recording light source for generating recording light providing a recording wavelength to record the optical information, and the fixing part includes a fixing light source for generating fixing light providing a fixing wavelength to fix the optical information.

3. The recorder according to claim 2, wherein the recording wavelength is different from the fixing wavelength.

4. The recorder according to claim 3, wherein the holographic memory medium includes at least one of a sensitizing dye and a polymerization initiator, for starting polymerization, and
wherein at least one of the sensitizing dye and the polymerization initiator has an absorption spectrum having a peak, the recording wavelength and the fixing wavelength are determined to cause the recording light to provide a first absorbance in the absorption spectrum at the recording wavelength and cause the fixing light to provide a second absorbance in the absorption spectrum at the fixing wavelength, and the second absorbance is higher than the first absorbance.

5. The recorder according to claim 3, wherein the holographic memory medium includes a sensitizing dye which has an absorption spectrum with a peak more than 0.1 after the fixing part that fixes the optical information, the fixing wavelength is determined to have the absorbance in the sensitizing dye equal to or lower than 0.1 at the recording wavelength in the absorption spectrum after the fixing part fixes the optical information.

6. The recorder according to claim 4, wherein the holographic memory medium includes a sensitizing dye which has an absorption spectrum with a peak more than 0.1 after the fixing part that fixes the optical information, the fixing wavelength is determined to have the absorbance in the sensitizing dye equal to or lower than 0.1 at the recording wavelength in the absorption spectrum after the fixing part fixes the optical information.

7. The recorder according to claim 3,
wherein the holographic memory medium includes a fixing sensitizing dye which has an absorption spectrum with a peak,
wherein the recording wavelength is determined to have a substantially no absorbance at the recording wavelength in the absorption spectrum, and
wherein the fixing wavelength is determined to have an absorbance in the absorption spectrum which is higher than the absorbance at the recording wavelength.

8. The recorder according to claim 4,
wherein the holographic memory medium includes a fixing sensitizing dye which has an absorption spectrum with a peak,
wherein the recording wavelength is determined to have a substantially no absorbance at the recording wavelength in the absorption spectrum, and
wherein the fixing wavelength is determined to have an absorbance at the recording wavelength in the absorption spectrum which is higher than the absorbance at the recording wavelength.

9. The recorder according to claim 5,
wherein the holographic memory medium includes a fixing sensitizing dye which has an absorption spectrum with a peak,
wherein the recording wavelength is determined to have a substantially no absorbance at the recording wavelength in the absorption spectrum, and
wherein the fixing wavelength is determined to have an absorbance in the absorption spectrum which is higher than the absorbance at the recording wavelength.

10. A method of recording optical information in a plurality of recording areas of a holographic memory medium, comprising the steps of:
recording the optical information in a first one of the recording areas by multiple-recording;
determining whether the step of recording the optical information in the first one is finished;
fixing the optical information in the first one of the recording areas when the determining part determines that the recording in the first one of the recording areas is finished; and
recording the optical information in a second one of the recording areas by the multiple-recording in parallel with or after fixing the optical information in the first one is fixed.

11. The method according to claim 10, wherein the optical information is recorded with recording light providing a recording wavelength, and the optical information is fixed with fixing light providing a fixing wavelength, the method further comprising the step of:
differentiating the recording wavelength from the fixing wavelength.

12. The method according to claim 11, wherein the holographic memory medium includes at least one of a sensitizing dye and a polymerization initiator, for staring polymerization which has a first absorbance at the recording wavelength and a second absorbance at the fixing wavelength, the method comprising the step of making the second absorbance at the fixing wavelength higher than the first absorbance.

13. A holographic memory medium for recording optical information, comprising: a recording layer including:
a recording sensitizing dye having an absorbance at a recording wavelength of recording light for recording the optical information; and
at least one of a fixing sensitizing dye and polymerization initiator which has substantially no absorbance at the recording wavelength and absorbance at the fixing wavelength of fixing light for fixing the holographic memory medium, the absorbance of at least one of the fixing sensitizing dye and the polymerization initiator at the recording wavelength is lower than the absorbance of at least one of the fixing sensitizing dye and the polymerization initiator at the fixing wavelength.

14. A holographic memory medium for recording optical information, comprising: a recording layer including: at least one of a sensitizing dye and a polymerization initiator which has an absorption spectrum with a peak for providing a first absorbance at a fixing wavelength of fixing light and a second absorbance at a recording wavelength of recording light, the second absorbance being lower than the first absorbance.

15. A recorder for recording optical information in a plurality of recording areas of a holographic memory medium, comprising:
a recording part that performs recording the optical information in a first one of the recording areas by multiple-recording;
a determining part that determines whether the recording in the first one of the recording areas is finished; and
a fixing part that locally fixes the optical information in the first one of the recording areas when the determining part determines that the recording in the first one of the recording areas is finished.

16. The recorder as claimed in claim 15, wherein the recording part records the optical information in a second one of the recording areas by the multiple-recording in parallel with fixing the optical information in the first one of the recording areas by the fixing part.

17. The recorder as claimed in claim 11, wherein the recording part records the optical information in a second one of the recording areas by the multiple-recording after the fixing part fixes the optical information in the first one of the recording areas.
